(19) United States
(12) Patent Application Publication
(10) Pub. No.: US 2017/0286618 A1
(43) Pub. Date: Oct. 5, 2017

(54) SUPPORT FOR LINKED INDIVIDUAL CARE PLANS ACROSS MULTIPLE CARE PROVIDERS

(71) Applicants: Medisked, LLC., Rochester, NY (US); Life Care Data Exchange LLC, Brookville, NY (US)

(72) Inventors: Jan Abelseth, Plainview, NY (US); Brian Uzwiak, Germantown, MD (US); Douglas Golub, Washington, DC (US); Thomas Hogan, Lewiston, NY (US)

(21) Appl. No.: 15/477,963

(22) Filed: Apr. 3, 2017

Related U.S. Application Data
(60) Provisional application No. 62/316,750, filed on Apr. 1, 2016.

(51) Int. Cl. G06F 19/00

(52) U.S. Cl. CPC G06F 19/3418; G06Q 2220/00

(57) ABSTRACT

The system and method described is configured to generate, based on an assessment of the individual, a number of goal oriented care plans designed to effectuate the long term goals of the individual while providing data that updates and refines the care plans in response changes in the health of the individual.

### CROSS-REFERENCE TO RELATED APPLICATIONS

This application claims priority to U.S. provisional application Ser. No. 62/316,750, filed Apr. 1, 2016, which is hereby incorporated by reference in its entirety.

### INTRODUCTION

The present invention relates to a system and method for data processing in support of linked care plans associated with a specific individual across different care provider agencies.

### BACKGROUND

Managed care plans for individuals are often used to ensure that proper treatment options and conditions are set for an individual. Beyond care plans for specific medical treatments, care plans also have utility in assigning and setting goals designed to improve the overall health and wellness of the individual. However, individuals having intellectual and other developmental disabilities have extended and/or long term care and life goals that require the coordination of multiple provider agencies in order to assist these individuals. Thus, there is a need to both deliver high quality assistance to members of the developmentally disabled community and provide real-time or contemporaneous data to support each individual's choices and preferences for achieving their life goals. Traditional systems have not adequately addressed the need to share data among provider systems and lack the ability to transform raw information into actionable data upon which decisions can be made. The invention addresses these and other needs.

### SUMMARY OF THE INVENTION

In accordance with one aspect that can be implemented in one or more particular embodiments, systems and methods are provided for generating and managing individual care plans across multiple care providers. In one implementation, the system and method includes generating, within the memory of a first computer using an assessment generator module comprising code executing in a processor of the first computer, an individual assessment data object having a plurality of data values relating to at least one wellness metric for the individual. The generated assessment is transmitted to a second computer over a communications network where at least one individual life goal based on the data values associated with the individual is extrapolated to a first array within the memory of the second computer using a goal identifier module.

The contents of the first array are used to generate a care plan (GDCP) using a care plan generator module comprising code executing in a processor of the second computer. In one particular arrangement, the care plans are generated by combining each life goal in the first array with a plurality of care variables into a data object, wherein each care variable has a defined set of possible values and at least one of the plurality of care variable represents a care provider to provide care to the individual and at least one other care variable represents the amount of time needed to achieve the life goal.

The system and method described also incorporates an efficacy module, comprising code executing in the processor of the second computer configured to access a database of prior GDCPs and automatically select an initial value for at least one care variable of the newly generated GDCP based on a comparison of the new GDCP to the prior GDCPs.

The newly generated GDCP is transmitted over a communications network to at least one service provider computer located at a care provider facility where real time data on individual utilization of the care provider services is collected. The collected data is periodically transmitted to the second computer where the data is used to update the GDCP and the updated GDCP is distributed back to the at least one service provider.

These and other aspects, features and advantages of the present invention can be further appreciated from the following discussion of certain more particular embodiments.

### BRIEF DESCRIPTION OF THE DRAWINGS

The foregoing and other features of the present invention will be more readily apparent from the following detailed description and drawings of one or more exemplary embodiments of the invention in which:

FIG. 1 is a schematic diagram detailing various components of an embodiment of the present invention.

FIG. 2 is a flow chart detailing the various steps of the system embodied in FIG. 1.

FIG. 3 is a schematic diagram detailing various modules of the embodiment FIG. 1.

FIG. 4 is a diagram of several goal-directed care plans according to the present invention.

FIG. 5 is a diagram of the assessment data table according to the present invention.

### DESCRIPTION OF ILLUSTRATIVE CERTAIN EMBODIMENTS OF THE INVENTION

By way of overview and introduction, the systems and methods are provided for improved data processing in support of generating and managing individual care plans, such as linked individual care plans, across multiple care provider agencies. In accordance with broad aspects, a collection of data points that quantifies an individual's overall health, wellness and life plan goals is received from distributed computational devices (e.g., iPads® by Apple, Inc. or tablets generally available from other suppliers, more generally “data processing devices”) and is configured so as to generate a master care, or life plan that objectively selects and implements various care options that will assist the individual in achieving the valued outcome using specific rules and preferably data associated with other individuals' outcomes in regard to the performance of their respective wellness and life plans. In one particular embodiment, a suitably configured computer system quantifies individual care goals, generates an overall care plan, and distributes goal specific plans to care providers. The system is further configured to provide real-time, contemporaneous, semi-contemporaneous or periodic updates to both the goal-specific and overall care plan in response to changes in the health of the individual. In this way, the systems and methods described herein provide technical solutions to the conventional problems faced by manually constructed, subjective individual care plans that lead to uneven or incorrect care plan generation by plan creators when interpreting similar data.

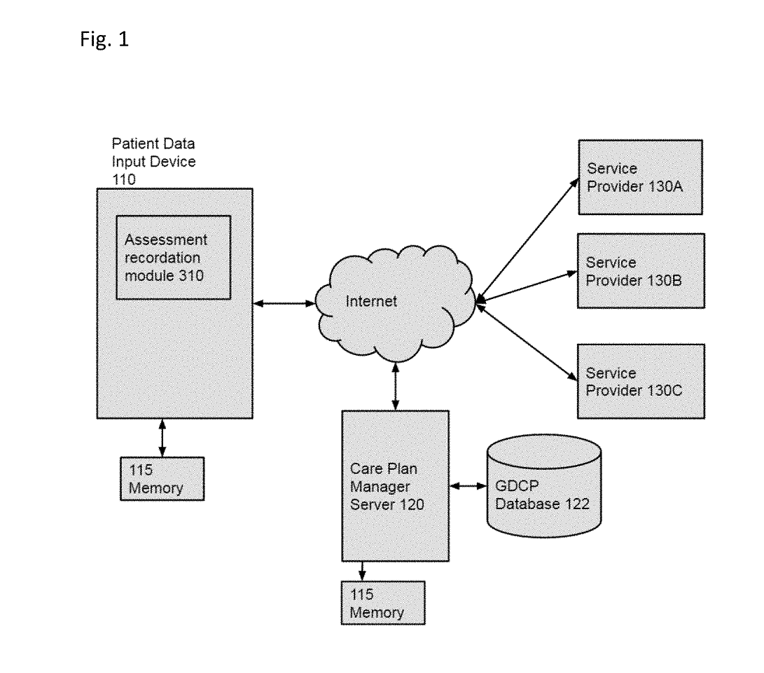

With reference to FIG. 1, one implementation of the system described incorporates a plurality of data processing devices, e.g. computers, configured to cooperate with one another in order to obtain data about an individual, generate care plans for that individual, and distribute the care plans to the relevant care provider agencies. Each such data processing device or, equivalently, computer system, computing device, or other terminology connoting the same, includes a hardware processor, physical non-transitory memory, and other components that permit receiving and outputting information, data processing, and communication to other devices.

In a specific embodiment, an individual data input device 110 is used to collect individual assessment data and send that data to a care plan manager 120 computer system. For example, the care plan manager 120 can be a server or other computing system that is local to, or remote from, the individual data input device 110. The care plan manager 120 develops customized, agency specific, care plans that are transmitted to local care provider computer systems 103A-C located at specific care facilities.

### Generating the Assessment

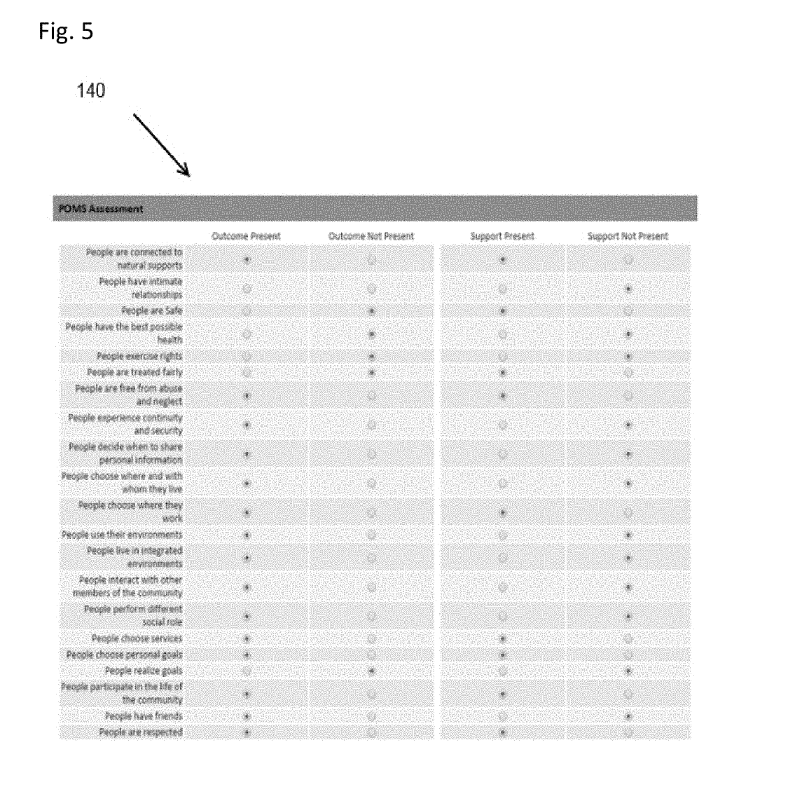

In further detail, the individual data input device 110 records individual assessment data through the use of a data template 140, such as a template of the type shown in FIG. 5, by way of example and not limitation. The data template 140 is used to store specific information relating to an individual. In one configuration, the assessment is created by inputting data into a data template using input fields, e.g., check boxes, drop-downs, and text fields that correspond to specific health or behavioral conditions and long terms goals of the individual. Data can be input or otherwise captured in other ways, but it is contemplated that the data is recorded in the field, that is, within a health care environment. In certain implementations, the data template 140 is provided by pre-existing templates stored in memory at the individual data input device 110 or the care plan manager server 120. In yet a further implementation, the individual input device 110 is configured by one or more modules to generate a data template from information stored in a data store or database. For example, question and answer sets, decision trees, or other information gathering prompts are stored individually as entries in a database. A suitable configured individual input device can generate from the individual entries in the database a custom template. Here, the custom template is tailored for a specific individual or class of individuals having common needs or traits.

For ease of use in the health care environment, the individual input device 110 used to input data into the assessment can comprise a portable computing device such as an Apple Ipad® or Android® device or other commercially available mobile electronic device having one or more processors, or multicore processors and associated memory and components. In some implementations, the individual data input device 110 can comprise a desktop computer or workstation class computer that executes a commercially available operating system, e.g., MICROSOFT WINDOWS, APPLE OSX, UNIX or Linux based operating system implementations. In accordance with further embodiments, the individual input device 110 comprises custom or non-standard hardware configurations. For instance, the individual input device 110 may comprise one or more micro-computer(s) operating alone or in concert within a collection of such devices, network adaptors and interfaces(s) operating in a distributed, but cooperative, manner, or array of other micro-computing elements, computer-on-chip(s), prototyping devices, “hobby” computing elements, home entertainment consoles and/or other hardware.

The individual input device 110 can be equipped or is in communication with a persistent storage device that is operative to store the operating system in addition to one or more of software modules.

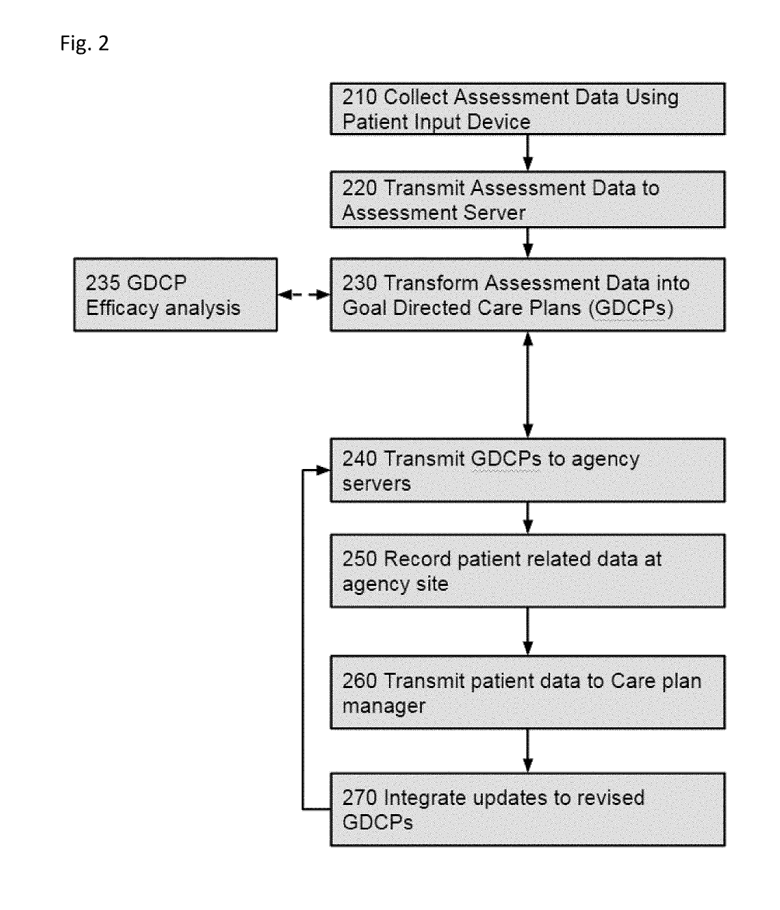

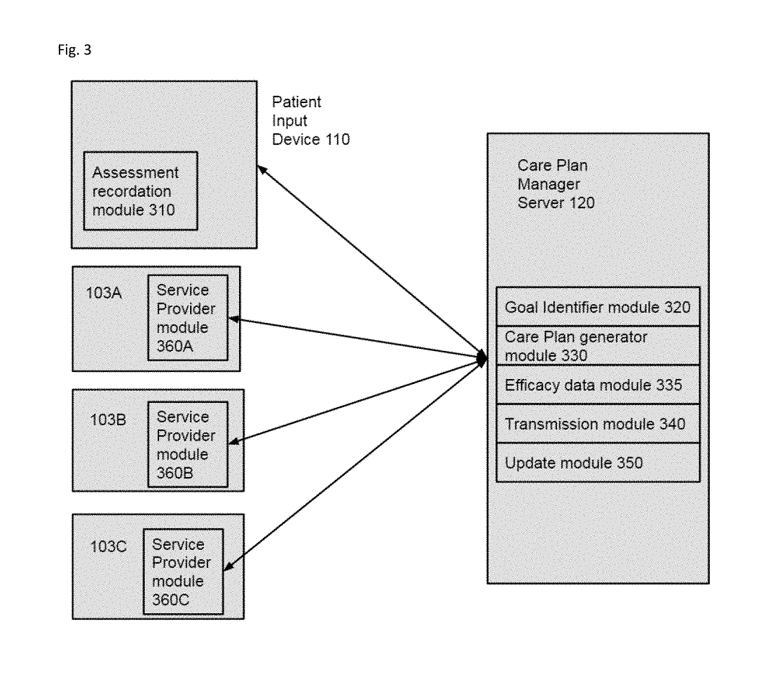

Turning to FIGS. 2 and 3, an assessment recordation module 310 configures a processor of the individual input device 110 via code executing in the processor so as to receive user input and provide prompts to the user to determine the type of information to be entered, as shown at step 210.

In one implementation of the data template 140, new data fields and follow-up assessment inquiries are dynamically generated based on the particular user inputs. For example, the code implementing the data template 140 uses branching and looping logic to configure subsequent data inputs in response to prior input data, and optionally in response to other information received from computers associated with the care plan manager, one or more service providers, or a combination of these devices. In this way, the logic provides an objective, specific rules-based system for parsing new data fields and inquiries that solves the problem of subjectively determining how to process answers to assessment inquiries. The logic can be implemented as code executing in the processor to update the template as required. As such, the template 140 should be appreciated as being a living input form that changes in accordance with data input at the health care environment and remote information received over a network.

The hardware processor of the individual input device 110 is further configured by code executing in an assessment recordation module 310 so as to create a individual assessment data object or file that includes data values indicating the particular individual's demographics, contacts, living arrangements, employment goals and history, diagnosis codes, legal representations, support structures, communication abilities, happiness values, overall health scores, medications, visions, skill sets, supervisions, adaptive equipment and personal care preferences. For example, the assessment recordation module 310 can implement programming that instantiates a data object or populates a file with the values received from the individual input device that includes information relating to at least one of the individual's demographic data, contact information, living arrangement location, employment goals, diagnosis codes, legal representation, support structures, communication preferences, overall health scores, medication, vision and skill sets. Additionally, the assessment recordation module 310 provides data values indicating the particular individual's preferences for various tasks, goods, services, environments, providers, agencies, activities, and other personal preferences that are relevant to life goals and personal happiness or satisfaction. By way of non-limiting example, the conditions or factual inquiries are evaluated by the assessment recordation module 310 and data values are associated with each: Core, Assessment, Current Durable Medical Equipment/POS, How I Communicate, The People In My Life, The People In My Life—An Overview, Where I Live, Where I Work, My Diagnosis, Legal, Self Direction, My Happiness, In The Way Of My Happiness, Supervision, My Health—Review of Preventive Services, My Health—History and Current Conditions, My Health—Medications, My Health—Goals and Actions, My Health—An Overview, My Nutrition, My Vision, My Mobility, Toileting, My Skill Matrix—Personal Hygiene, My Skill Matrix—Daily Living, Supportive Routines for PHS ADLS, Safety Plans, Reasonable Accommodations, Durable Medical Equipment/POS Summary, Preferences, and Notes.

In one or more embodiments of the present invention, the individual data input device 110 is further configured by code executing so as to implement the assessment recordation module 310 to add additional information about the individual to the assessment via coordination with additional data sources. For example, the assessment recordation module 310 can add to any data object or file health insurance provider information, financial status, or other relevant data that is not captured in the data template 140. In one particular arrangement, the assessment data is stored as a digital file on a local memory device, e.g., a hard drive associated with the individual input device 110. In an alternative arrangement, the assessment is only stored temporarily in the volatile memory of the computer device and configured so that, upon transmission to the assessment server (e.g., the care plan server 120, which is a species of computing device as described above), there is no long term copy of the assessment stored on the local memory of the individual input device 110. In a specific implementation, the assessment is encoded and transmitted to the care plan server 120 as a data stream and not as a single digital file. In another configuration, the individual input device 110 connects to a web application stored on the care plan management device 120 and provides a data exchange directly to a storage location utilized by the care plan management device 120 via a web service executing on the care plan server 120, or on a web server in communication with the care plan server 120.

FIG. 1 details the connection between the individual data input device 110 and the care plan manager server 120. The individual data input device 110 transmits individual data, e.g., assessment data that had been entered into the data template 140, to the care plan management server 120, preferably using wireless communications protocols, as indicated at step 220. It will be appreciated that in alternative configurations, other short or long-range wired and wireless communication protocols can be used to transfer data from the individual input device 110 to the care plan manager server 120. Furthermore, data can be exchanged between the computing devices described herein by exchanging physical storage media, such as flash or other non-volatile memory devices. Furthermore, in preferred implementations, the individual data input device 110 encrypts the data template 140 prior to transmission. The encryption level implemented, in one configuration, is sufficient to meet or exceed HIPPA compliance standards.

In a particular configuration, the individual data input device 110 implements connection-testing as part of a transmitting process in order to determine if a connection to the care plan manager 120 is available. Upon establishing a connection with the care plan manager 120, the individual input device 110 transmits the assessment and any accompanying information to the care plan manager server 120. In the event that connection cannot be performed, code executing in the patent data input device configures the device to provide functionality to the user, including commencement of assessment recordation of a different individual, until such time that one or more assessments and accompanying information for one or more respective individuals are communicated to the care plan manager server 120. Until such time that the connection can be established and the transmission to the care plan manager server 120 has completed, the assessment recordation module 310, or other code associated therewith, executes as a background process. In a further arrangement, the individual data input device 110 is configured to send the assessment to multiple Care Coordinator Organizations or Managed Care Organizations or other computer systems configured and capable of receiving the assessment data.

In a particular implementation, one or more Care Coordinator Organizations or Managed Care Organizations, whose individuals Care Coordinators & Care Managers (i.e. users) operate the individual data input device 110. These users are able to capture the assessment data assessment and update and or manage individual assessments either directly on the individual data input device 110, or though a direct link to connection to a remote care plan manager 120, or through a web-based access portal to the remote care plan manager 120 manage it (second computer) using a web browser.

### Generating the Care Plans

In a particular arrangement, the care plan manager 120 is a computer, server or collection thereof, equipped with one or more processors configured by code executing therein to implement the modules provided in FIG. 3. The hardware processor (not shown) of the care plan manager 120 is configured to access the assessment data transmitted by the individual data input device 110. As shown in step 230, the goal identifier module 320 configures the processor of the care plan manager 120 to extrapolate the assessment data into a collection of outcome-directed care plans that are tailored to specific provider agencies. The extrapolation process can be implemented in one or more embodiments, but it should be noted that the assessment data is processed by code executing in the care plan manager server to arrive at the tailored objective outcome-directed plans, as described next.

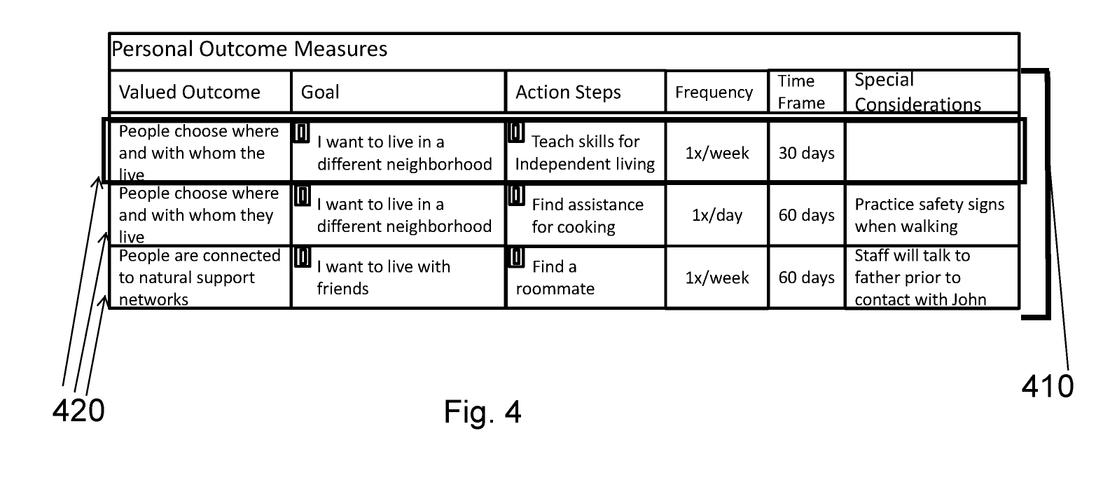

In a particular implementation, the assessment data is evaluated and information relating to individual's heath, physiological and behavioral states, as well as goals and desired outcomes, are converted into a life plan 410 for that particular individual. As provided in FIG. 4, the life plan 410 can comprise a collection of life goals and action steps 420 unique to the individual and which are based on data obtained from the assessment. In one particular context, the life plan 410 is a collection of database tables, linked or unlinked arrays, relational data structures, or a collection of independent data structures or elements associated with a particular individual.

In accordance with one aspect of the invention, the data transformation step 230 is implemented by the goal identifier module 320 which comprises code that configures one or more processors to extract individual information from the assessment utilizing text or data parsing techniques. For example, natural language processing submodules configure the care plan manager server 120 to extract information relating to the individual goals, desired time frames for outcomes, frequency of desired treatments or assistance, or action steps form the assessment and store them as part of a life plan data structure 410. In one particular arrangement, the life plan data structure 410 contains information that indicates that the individual is assigned to one or more groups of other individuals having similar assessments. For instance, care plan manager server 120 can be configured to group individuals based on living situations, and then further stratify individuals based on the health or behavioral needs or challenges associated with the individual. In this way, the data transformation step 230 provides an automatic rule-based generation of outcomes.

Each individual goal or valued outcome 420 identified in the life plan data structure 410 is used to generate a goal directed care plan (GDCP) for that specific goal or outcome. The GDCPs define Individual Plans of Protective Oversight, sometimes referred to as IPOPs. The GDCPs are specific care plans designed to help the individual achieve their desired outcome. In a particular embodiment, the GDCPs are data tables, care variables or data elements that indicate a desired goal obtained from the assessment. In one specific example, a generated GDCP includes data features relating to further steps necessary to achieve the individual's ultimate goal or valued outcome. For instance, the GDCP data features include data values corresponding to specific providers or institutions, sequential prompts relating to desired outcomes, question sets, evaluation, tests, decision trees, or cascading or branching logic. Additionally, the data values can be care variables that are resolved to specific values, text, images, or signals at a later time in response to prior obtained outcomes. In a further arrangement, the GDCP data features are derived programmatically or automatically using one or more machine learning modules designed to evaluate existing or prior GDCPs and generate new GDCP based on outcomes and other feedback data.

In one implementation, the care plan generator module 330 includes submodules comprising code that configure the processor to generate GDCPs automatically based on the information from the assessment using pre-defined rule sets applied to the desired goal, available provider agencies, and time frames.

In a further implementation, each GDCP generated or selected is provided with an intimal data value or variable. For example, where a GDCP is generated relating to living arrangements, a default or initial value is selected and incorporated into the GDCP. A user may then alter or customize the data feature of the GDCP at any time after generation.

As a non-limiting example, the assessments for an individual can identify a goal of living independently. The care plan manager 120 executes code configured to automatically generate a GDCP for achieving the desired outcome. Here, the care plan generator module 320 comprises code that configures the processor to automatically select a care provider from a list of approved providers that specializes in the patent's desired goal. As seen in FIG. 4, the care plan generator module 320 has further code that configures the processor to automatically select an appropriate time frame and reporting frequency useful in accomplishing the desired goal. In this way, an objective GDCP is generated that improves upon subjective or manual GDCP generation by eliminating bias, redundancies, and maintains consistent GDCPs across different individuals sharing similar individual health profiles.

The care plan manager 120 can also comprise code that configures the processor to generate data for inclusion in to the GDCP based on the specific care agency responsible for overseeing that the individual achieves the particular valued outcome. For instance, a individual that seeks increased job skills will have a GDCP that is generated to achieve the desired outcome. The agency tasked with assisting the individual in achieving the desired outcome is selected from a pre-set group of provider agencies based on the provider profiles. As a non-limiting example, the care plan manager server 120 is configured, by code executing in the processor, to evaluate the capacity of provider agencies to assist the individual based on the number of other individuals the agency in question is assisting.

Additionally, historical and statistical data from past and pending GDCPs can be incorporated into the selection process and used to assist in the automatic selection of a provider agency and time frame for achieving the goal. In one arrangement, an efficacy module 335 comprises code that configures the processor of the care plan manager 120 to access a database 122 of previously generated GDCPs. As used here, each GDCP in database 122 has outcome data associated with it. In other arrangements, partially complete or incomplete outcome data can be used.

Here, the care plan manager server 120 is configured, using an efficacy data module 335, to implement, via code associated therewith and executing in the processor, efficacy analysis step 235 to access stored data relating to the efficacy of different GDCPs for existing or prior individuals. The efficacy step 235 includes configuring the processor of the care plan generator 120, using the efficacy data module 325, to access stored data profiles of the agencies that provide oversight and implementation of the GDCPs. In the present context, the provider profiles are data compilations of service providers that contain constantly updated metrics relating to service provider evaluations. In a particular embodiment, the data and metrics relate to the rates or incidents of successful completion of individual life goals using that specific provider, update frequency of GDCPs by the provider, provider preferences, action-steps undertaken by the provider, incident reports, safety hazards, violations, or other data. In a further iteration, the efficacy data includes updates to financial, governmental, community or other support services for a specific individual, or groups of individuals.

In a further evaluation, the care plan manager 120 is configured by code associated with the efficacy module 335 executing in a processor so as to perform statistical analysis on the pending and prior GDCPs stored in database 122. For example, through the use of regression analysis, machine learning or neural networks, an optimized care plan for a particular individual can be generated based on prior outcomes, or outcome measures (sometimes referred to as Personal Outcome Measures, or POMs). For example, a statistical analysis of same of similar goals for other individuals that have achieved the progress desired is undertaken by a processor configured by the efficacy analysis 335. Based on the results of the statistical analysis, the care plan manager 120 can be configured to automatically generate at least some of the data features for the particular goal associated with a GDCP. In one non-limiting example, the care plan manager 120 can generate a data feature correlating to an increased frequency of physical therapy, or care provider visits for a given individual having similar circumstances to prior individuals. Likewise, additional data features can be added to the GDCP to incorporate further goals services such as a change in provider or additional support where individuals in similar circumstances had improved results. In the present context, the efficacy module 335 includes sub-steps for generating a data model configured to output a predicted efficacy value for the combination of features for a specific personal outcome goal. The model is generated, in one instance, using a regression algorithm that evaluates the data features found in prior GDCPs where the outcomes are known and iterating combinations of data features for the GDCP and evaluating them with the model. The results of the iteration yield the combination of data features that, when selected as part of the GDCP, will yield the highest efficacy value.

As an example of the described efficacy evaluation, the care plan manager server 120 executes code that generates a customized GDCP based, in part, on supplemental data obtained from former residents of a group home who achieved a valued outcome of living independently and applies that data to a current individual having the same desired outcome.

In a further arrangement, the care plan manager server 120 executes code that automatically selects the timing intervals of the action steps or interventions, as well as a time frame to achieve the individual's valued outcome. In a particular embodiment, the care plan generator module 330 utilizes the supplemental information to dynamically select some or all of the conditions of the GDCP (e.g., timing, frequency, action steps). For example, in the event that multiple agencies are capable of assisting the individual in achieving the valued outcome, the care plan manager is configured by code associated with the GDCP generation module 330 which executes in the processor to rank or evaluate the providers based on the provider data and select the closet agency to the individuals living arrangements. In an alternative arrangement, the GDCP generation module 330 executes code that is used to generate a GDCP in which the agency provider selected has the highest percentage of successful outcomes of prior GDCPs that were assigned to that agency.

In an alternative examination of the system described, the care plan manager server 120 executes code that configures the processor to access data relating to the health insurance coverage and financial support available to the individual. In one arrangement, the care plan management system described is configured by executing code to select a provider agency that accepts the individual's health insurance. In a further arrangement, the care plan manager also executes code that configures the processor to look up addresses, including executing queries to a geolocation database, to find the location of a service provider and select one in a preferred neighborhood or in close proximity to family or community support. In a further arrangement, the care plan management server 102 executes code to identify qualified/preferred providers based on at least provider specialty or other taxonomy of care considerations.

Returning to the generation of the GDCPs, the care plan manager server 120 generates GDCP(s) for an individual that includes the goal(s), the provider(s), action steps, and derived or calculated frequency and time frames based on statistical data modeling of previous prior and on-going GDCPs. Upon generation of one or more GDCPs for an individual, the each individual GDCP is transmitted, using a transmission module 340, to the selected agency service provider, as shown at step 240.

In a particular configuration of the care plan management system, the agency service providers are remote facilities that engage in the care and assistance of the individual. Each service provider is equipped with a network accessible computer, or computer network that is configured through software modules to receive the GDCP(s) from the care plan manager 120 and display the care plan to care workers. As shown in FIG. 3, the provider agencies are equipped with a service provider module 360A-C for accessing, downloading, or retrieving the GDCP from the care plan manager 120.

Once the relevant agency provider is in possession of the GDCP, such as one directed to independent living, the individual is monitored by a service provider for changes or compliance with the specific GDCP as well as for general health, safety and wellbeing by the agency staff. The data relating to the individual's general health, as well as the steps towards achieving the GDCP valued outcome are recorded against the GDCP. Data regarding the current state of the GDCP is entered as inputs in a data file or object and is sent back to the care plan manager 120 using the service provider module 360A-C as provided in step 250. In one arrangement, the service provider module(s) 360A-C are local software programs operating on the service provider's local computers or network. In an alternative arrangement, the service provider modules 360A-C are web-interfaces that provide the ability to communicate and transfer data directly with the care plan manager 120. In a particular arrangement, the GDCP is updated according to a set frequency, e.g., daily, weekly.

The care plan manager server 120 is configured to receive these updates by an update module 350 that executes code, as indicated at step 260. The update module 350 receives the GDCP updates from the service providers and stores them in a data storage location, such as a database of individual updates. Likewise, the original GDCP is updated according to these data inputs such that when goals are achieved, the GDCP is no longer sent to the service providers as in step 270, and the change in status is noted in the life plan data structure 410 as a completed goal or valued outcome achieved. Once the original GDCPs are revised, it is transmitted back to the service providers for use in assisting the agencies in achieving the individual's valued outcome. The update and transmittal process is repeated at set intervals, e.g., daily, weekly, and/or monthly, until the valued outcome of the GDCP is achieved or removed from the life plan.

In another arrangement, the progress of a particular individual in achieving the goal of the GDCP is used to update the statistical modeling used to automatically select the provider agencies and features of used for new GDCPs. Furthermore, the progress information for each GDCP handled at a particular care location is utilized to update the provider profile to enhance efficiency in the generation and selection of provider agencies.

In a further implementation, the care plan manager 120 uses the GDCP update information to update other GDCPs such that a change in status for the individual regarding specific GDCPs will cause a change in the other GDCPs associated with that individual. In this way, disparate care agencies that service the same individual will be informed of changes to care, without the need for direct agency to agency communication. By way of non-limiting example, in the event that a service provider sends in the update information, data indicating an injury to the individual that alters mobility, information relating to the injury is received and stored by the care plan manager 120. The care plan manager 120 sends changes to the GDCPs at each care provider agency indicating that the frequency or duration of physical activity necessary to achieve that specific valued outcome be reduced or eliminated for a time period. For example, the physical activity necessary to achieve a specific valued outcome can be processed by executing code in update module 350 by the care manager 120 to output a suggested reduction or elimination of physical activity proportional to the injury.

While the invention has been particularly shown and described with reference to a preferred embodiment thereof, it will be understood by those skilled in the art that various changes in form and details may be made therein without departing from the spirit and scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Particular embodiments of the subject matter of the present invention have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

The above description of embodiments not intended to be exhaustive or to limit the systems and methods described to the precise form disclosed. While specific embodiments of, and examples for, the system and method are described herein for illustrative purposes, various equivalent modifications are possible within the scope of care coordination plan generation methods, as those skilled in the relevant art will recognize. Furthermore, the specific teachings of the care plan management system and methods provided herein can be applied to other health care management systems and methods, not only for the specific examples described above.

The elements and acts of the various embodiments described above can be combined to provide further embodiments. These and other changes can be made to the apparatus and methods in light of the above detailed description.

What is claimed is:

1. A computer implemented method of generating and managing individual care plans across multiple care providers for an individual, the method comprising:
generating, within the memory of a first computer using an assessment generator module comprising code executing in a processor of the first computer, a individual assessment data object having a plurality of health metric data values relating to the individual;
transmitting, with the first computer, the individual assessment data object to a second computer over a communications network;
extrapolating, to a first array within the memory of the second computer using a goal identifier module, at least one individual care plan based on the health metric data values associated with the individual assessment data object wherein the extrapolation includes correlating at least one health metric data value to at least one personal outcome goal stored in a database and storing each correlated personal outcome goal as a unique element in a first array;
generating, within the memory of the second computer using a care plan generator module comprising code executing in a processor of the second computer, for each element in the first array, a goal directed care plan (GDCP) by combining each personal outcome goal in the first array with a plurality of care variables into a GDCP data object, wherein each care variable of the GDCP has a defined set of possible values and at least one of the plurality of care variables represents a care provider to provide care to the individual and at least one other care variable represents either the amount of time or service activities needed to achieve the personal outcome goal;
accessing, by the second computer, a database of existing GDCP data objects;
comparing, using an efficacy module comprising code executing in the processor of the second computer, the personal outcome goal of the newly generated GDCPs and the personal outcome goals of the existing GDCP data objects and automatically selecting an initial value for at least one care variable value data feature of the newly generated GDCP data object based on the comparison;
transmitting the newly generated GDCP data objects over a communications network to at least one service provider computer located at a care provider facility;
collecting contemporaneous data on individual utilization of the care provider services;
periodically transmitting the collected data back to the second computer;
updating the newly generated GDCP data object based on the collected data using an update module comprising code executing in the processor of the second computer; and
transmitting, with a computing device, the updated GDCP data object back to the service provider computer.

2. The method of claim 1, wherein the updating step further includes selecting a different value for at least one care variable in response to the collected data.

3. The method of claim 1, wherein the individual assessment data includes information relating to at least one of individual demographic data, contact information, living arrangement location, employment goals, diagnosis codes, legal representation, support structures, communication preferences, overall health scores, medication, vision, skill sets, and an individual's preferences relating to specific tasks, goods, services, environments, providers, agencies, activities, and other personal preferences relevant to life goals and personal satisfaction.

4. The method of claim 1, wherein transmitting the individual assessment data further includes, testing a communication link between the first computer and the second computer prior to transmitting the individual assessment.

5. The method of claim 4, wherein upon failure to establish a communication link with the second computer, the first computer is configured by code executing therein to encrypt and store the individual assessment in a storage device accessible by the first computer.

6. The method of claim 5, further comprising,
establishing, with the first computer, a new connection with the second computer,
accessing the encrypted individual assessment; and
transmitting the encrypted individual assessment to the second computer.

7. The method of claim 1, wherein the comparing step further includes,
generating a data model configured to output a predicted efficacy value for the combination responses for a specific personal outcome goal, in which the model is generated using a regression algorithm to evaluate the data features found in prior GDCP data objects having known outcomes;
generating a plurality of evaluation GDCP data objects by iterating over the potential combinations of GDCP data object data values;
evaluating each evaluation GDCP data object with the data model, and
identifying the optimal combination of data features that correspond to the GDCP data object having a highest efficacy value and generating a individual GDCP data object with the optimal data features.

8. The method of claim 1, wherein the updating step further comprising, updating at least one other GDCP data object associated with an individual in response to the received collected data where the data indicates a change in individual status.

9. The method of claim 8, wherein the change in individual status includes, a change in health, safety, demographic, service support status of the individual.

10. The method of claim 1, wherein the care plan generator module further configures the second computer to automatically generate care variables values.

11. The method of claim 1, wherein automatically selecting the initial value of the care provider variable includes selecting care providers that have a location within a pre-set distance from the individual's living arrangement.

12. The method of claim 1, further including:
encrypting the individual assessment prior to transmitting the assessment to the care plan management server;
encrypting the GDCP prior to transmitting to the service provider device, and
encrypting the updated GDCP data object.

13. An individual care plan generation and management system including:
a individual data collection device configured to receive user input and store user input to a individual data template and equipped with a data transmitter to communicate with a data network;
a care plan management server having at least one processor and configured by code executing therein to receive data from the individual data collection device over the data network, extrapolate the individual data template into a first array, wherein the extrapolated data represents a personal outcome goal for the individual, generating a goal directed care plan (GDCP) for each element in the first array where the GDCP includes a plurality of variable value data features, accessing a database of prior GDCPs, automatically selecting the value for at least one variable value data feature based on a regression analysis of prior GDCPs, receiving user input and setting the value of each variable value data feature not automatically selected based on the received user input, transmitting the GDCP to a care agency, and receiving from the care agency data relating to the progress made in accomplishing the personal outcome goal;
a care agency device remote from the care plan management server and configured to receive the GDCP plan; and
record data to the GDCP related to progress achieving the personal outcome, and transmit the recorded data to the care plan management server.

14. The system of claim 13, wherein the individual data collection device is configured to retrieve the individual data template from a remote server device and store the individual data template in a local non-volatile memory location.

15. The system of claim 13, wherein the care plan management server is a collection of distributed computing elements.

16. The system of claim 13, wherein the individual data collection device is a mobile computing device equipped with a communications module for wirelessly transmitting data.

17. The system of claim 16, wherein the individual data collection device is further includes a location module for determining the contemporaneous location of the individual data collection device.

18. The system of claim 13, further including:
wherein the care plan management server is further configured to encrypt the individual assessment prior to transmitting the assessment to the care plan management server; and
encrypt the GDCP prior to transmitting to the service provider device.
